(19) United States
(12) Patent Application Publication
(10) Pub. No.: US 2026/0128433 A1
(43) Pub. Date: May 7, 2026

(54) BATTERY ASSEMBLY HAVING IMPROVED SEALING PROPERTIES AND MOTOR VEHICLE

(71) Applicant: AUDI AG, Ingolstadt (DE)

(72) Inventors: Martin DEHM, Monheim (DE); Ruben HEID, Bammental (DE); Florian KELLER, Gaimersheim (DE)

(73) Assignee: AUDI AG, Ingolstadt (DE)

(21) Appl. No.: 19/374,549

(22) Filed: Oct. 30, 2025

(30) Foreign Application Priority Data
Nov. 6, 2024 (DE) 102024132251.9

(51) Int. Cl. H01M 50/24; B60L 50/64; F16J 15/10; H01M 50/204; H01M 50/242; H01M 50/249; H01M 50/342; H01M 50/358; H01M 50/367

(52) U.S. Cl. CPC H01M 50/24; B60L 50/64; F16J 15/10; H01M 50/204; H01M 50/242; H01M 50/249; H01M 50/3425; H01M 50/358; H01M 50/367; H01M 2200/20; H01M 2220/20

(57) ABSTRACT

A battery assembly includes a cell group having at least one battery cell which has a releasable cell degassing opening, a carrier plate having a first carrier side, a second carrier side, and a passage area opposite to the releasable cell degassing opening as part of a degassing area of the carrier plate, a protective plate arranged below the carrier plate and facing toward the second carrier side, and a first degassing chamber between the protective plate and the carrier plate. A sealing layer is arranged on the second carrier side covering the degassing area and separates it from the first degassing chamber. A second degassing chamber is formed between the degassing area and the sealing layer to temporarily fluidically separate from the first degassing chamber in case of degassing.

### FIELD

The invention relates to a battery assembly for a motor vehicle, which comprises a cell group having at least one battery cell that includes a releasable cell degassing opening. In addition, the battery assembly comprises a carrier plate having a first carrier side, having a second carrier side opposite to the first carrier side, and having at least one passage area assigned to the at least one battery cell, wherein the at least one battery cell is arranged on the first carrier side in such a way that the releasable cell degassing opening faces toward the first carrier side and is opposite to the passage area. Furthermore, the battery assembly comprises a protective plate arranged below the carrier plate with respect to a specific direction and facing toward the second carrier side of the protective plate, and a first degassing chamber between the protective plate and the carrier plate, into which, in case of degassing, a gas emerging from the releasable cell degassing opening is introducible through the passage area. Furthermore, the invention also relates to a motor vehicle having such a battery assembly.

### BACKGROUND

Batteries, for example, high-voltage batteries for motor vehicles, often comprise numerous individual cells. Each of these individual cells could suffer a thermal runaway, i.e. run away thermally, due to various causes. The goal in this case is to keep the cells as susceptible as little as possible to such a thermal runaway. For this purpose, specific cell chemistries can be used or cell housings can be designed to be as robust as possible. In addition, cell housings can comprise targeted weak points, also called cell vents, and which are referred to herein as releasable cell degassing openings. These enable targeted outgassing or targeted burnout of the cell in case of a thermal runaway. Other measures can also be used, for example, targeted isolation of the cells from each other, for example by using inter-cell material, by protecting the electrical potential-bearing surfaces, and the like. Such measures can often delay or even stop the propagation of thermal runaway from one cell to other cells. In the case of a stop after the Xth cell thermal runaway, it is also referred to as “stop TP (thermal propagation)”. In the case of a stop after the first cell experiencing thermal runaway, it is also referred to as “No-TP”, which means that no thermal propagation to other cells takes place.

In order to enable targeted degassing of a cell experiencing thermal runaway, it is advantageous to connect the cell vent to a degassing volume, which enables targeted discharge and cooling of the harmful gas. Ideally, the connection should be such that the cell experiencing thermal runaway is not blocked in its outgassing behavior. A blockage of the cell experiencing thermal runaway at the cell vent could result in unwanted burnout at other cell positions. To provide the freest possible degassing of a cell experiencing thermal runaway and the removal of the harmful gas via a degassing volume, openings or interfaces can be created between the degassing chamber and the cell vent. Free degassing into the surroundings instead of into a degassing chamber is undesirable due to the high oxygen content in the surroundings and the resulting immediate fire in the vehicle surroundings. These interfaces or openings between the cell and the degassing chamber can, for example, be implemented as a perforated plate, in which each cell sits cut out on a plate in the area of the cell vent. Larger cutouts across a larger number of cells are also possible. If the cell vents are directed downwards with respect to a vehicle vertical direction, in particular the space above the underrun protection of the motor vehicle can be used as a degassing chamber. However, the difficulty here is that the battery compartment, in which the battery cells are located, has to be reliably protected against the entry of water, dust, contaminants, and the like, but the underrun protection is directly adjacent to the surroundings of the motor vehicle and is therefore particularly susceptible to apotential entry of water or dirt or the like. Sealing off the underrun protection from the battery is particularly difficult due to the size of the battery and the corresponding size of the underrun protection. Sealing in the area of the cells or through openings is also not easy to implement, since it must be ensured that the cells can degas freely and are not blocked by waterproof structures directly on the cells. Conversely, sealing structures cannot be made excessively thin, so as not to lose their sealing effect over their service life. Due to the large geometry of the battery, component tolerances, reversible and irreversible cell growth, thermal influences, driving movements, and the like, the tightness of the high-voltage battery has heretofore only been able to be achieved with enormous effort.

DE 10 2022 121 801 A1 describes a battery having battery cells and a battery housing which has a perforated plate on which the battery cells are placed, wherein the perforated plate has an assigned degassing opening for each battery cell, on which the assigned battery cell is placed and via which gas emerging from the respective assigned battery cell can be led out of the housing interior. The degassing openings can be sealed by means of a sealing layer which is configured to be penetrated by hot gas flowing out of the battery cells in case of a thermal runaway. The sealing layer can comprise an adhesive layer, via which the battery cells are adhesively bonded to the perforated sheet. Furthermore, a tray can be arranged on a side of the perforated sheet opposite to the battery cells, which tray, together with the perforated sheet, encloses a buffer volume in which an impact absorption foam is arranged. The tray can be tightly connected to the perforated sheet. The tray can also be used as bollard protection. In addition, the tray can have a sandwich structure.

DE 10 2022 115 489 B3 describes a battery-electric vehicle having a battery and a frame structure which encloses the battery receptacle space in the circumferential direction, wherein the battery degassing space has a mounting opening on a bottom side for mounting and dismounting the battery. The mounting opening is closed using a cover plate which is arranged below the frame structure, wherein a seal is arranged to seal off the cover plate from the frame structure. In addition, the vehicle comprises an underrun protection plate on the vehicle bottom, which is located below the cover plate and protrudes laterally beyond the cover plate. The underrun protection plate can be sealed off from the frame structure and/or cover plate by means of an additional seal.

### SUMMARY

The object of the present invention is to provide a battery assembly and a motor vehicle which make it possible to seal the interior of a battery in the simplest and most cost-effective manner possible without obstructing the outgassing of a battery cell in case of a thermal runaway thereof.

A battery assembly according to the invention for a motor vehicle comprises a cell group having at least one battery cell having a releasable cell venting opening, a carrier plate having a first carrier side, a second carrier side opposite the first carrier side, and at least one passage area assigned to the at least one battery cell, wherein the at least one battery cell is arranged on the first carrier side such that the releasable cell venting opening faces toward the first carrier side and is opposite to the passage area, and wherein the carrier plate has a degassing area in which the passage area is arranged. In addition, the battery assembly comprises a protective plate arranged below the carrier plate with respect to a specific direction and facing toward the second carrier side of the protective plate, as well as a first degassing chamber between the protective plate and the carrier plate, into which chamber a gas emerging from the releasable cell venting opening is introducible through the passage area in case of degassing. The battery assembly comprises a sealing layer which is arranged on the second carrier side, which is joined to the second carrier side to form a seal along at least one closed sealing contour which runs in a closed manner around the degassing area of the carrier plate and which covers the degassing area and separates it from the first degassing chamber, wherein a second degassing chamber is formed between the degassing area and the sealing layer or can be formed in case of degassing, and wherein the battery assembly is designed such that the second degassing chamber is only temporarily fluidically separated from the first degassing chamber in case of degassing and that a fluidic connection is established between the first and second degassing chamber in case of degassing.

The sealing layer provides a particularly advantageous sealing option for sealing a battery interior. The great advantages of the provided sealing layer are precisely that it forms a second degassing chamber, either permanently or at the latest in case of degassing, which borders on the passage area of the carrier plate. This means that, at the latest in case of degassing, the sealing layer does not directly abut this passage area, which significantly simplifies the passage of gas through the passage area and accordingly into the second degassing chamber. This provides a reliable outgassing option for the at least one battery cell. In addition, as long as no degassing takes place, the sealing layer separates the first degassing chamber from the degassing area of the carrier plate and thus also from the battery interior, due to which the sealing layer provides additional protection against the penetration of liquid or dirt or dust or contaminants from the first degassing chamber via the passage area into the interior of the battery. In the case of degassing, however, this separation between the first and second degassing chambers only exists temporarily, because in the case of degassing, a fluidic connection is ultimately established between the first and second degassing chambers, due to which the gas introduced into the second degassing chamber via the passage area can reach the first degassing chamber via this fluidic connection and can be discharged via this, for example into the surroundings. The battery assembly thus enables reliable sealing of a battery interior without impairing the outgassing of the affected battery cell in case of degassing.

The battery interior is located in particular on the side of the carrier plate on which the cell group is also located and is adjacent in particular to the first carrier side.

The sealing layer does not have to be the only sealing measure for sealing the battery interior, but can also be combined with other sealing measures, for example, one or more of the sealing measures mentioned at the outset. In case of one sealing measure failing, the redundancy still provides sufficient, reliable sealing protection.

The at least one battery cell can be designed, for example, as a round cell or pouch cell or prismatic battery cell. In addition, the at least one battery cell can be, for example, a lithium-ion cell. The cell group can optionally also comprise multiple battery cells. Further optional battery cells can then be designed accordingly, as described above and below for the at least one battery cell.

A releasable cell degassing opening is to be understood as an opening that is closed and can be released, i.e. opened, under certain circumstances. Such a releasable cell degassing opening can therefore have a closed state and an open state and can pass from the closed state to the open state. This transition does not have to be reversible. It can be that a transition from the open state to the closed state is no longer possible, for example, in the case of a cell degassing opening designed as a bursting membrane. The releasable cell degassing opening can also be designed such that a transition from the open state to the closed state is possible, for example, if the releasable cell degassing opening is designed as a pressure relief valve.

The releasable cell degassing openings can be designed as passively pressure-dependent releasable cell degassing openings, for example, as a pressure relief valve and/or bursting membranes and/or predetermined breaking points in the cell housing, or the like. The releasable degassing opening is normally closed in this case and thus separates the interior of a respective battery cell from the environment in a fluid-tight manner. Above a certain overpressure, a respective such cell degassing opening opens and thus provides a fluidic connection between the interior of a respective battery cell and its surroundings in order to allow gas to escape from the battery cell.

If, for example, the cell group comprises multiple battery cells having respective releasable cell degassing openings, these releasable cell degassing openings are located opposite to a respective or common passage area of the carrier plate. This passage area or the respective passage areas are then all arranged in the same degassing area of the carrier plate. The degassing area thus represents, for example, a contiguous area of the carrier plate in which all passage areas that are assigned to at least one of the same cell groups are arranged.

The carrier plate can optionally be a cooling plate. In other words, the carrier plate can also comprise cooling channels through which a cooling medium can flow and, during operation, can have such a cooling medium flow through them to cool the battery cells. In this case, it is advantageous if the passage area assigned to the battery cell is arranged in an area of the carrier plate in which no cooling channels extend. In addition, the carrier plate can also represent part of a battery housing in which the cell group is arranged. For example, the carrier plate can be designed as the housing base of the battery housing.

The passage area can be a predetermined breaking point or a point having a material weakening or a permanent opening or a hole. For example, the passage area can be designed as a through opening in the carrier plate, which can optionally be covered by a protective layer and/or protective film of the battery assembly. The protective layer covering the through opening can be provided, for example, in the form of an insert or a film cover. If the cell group comprises multiple battery cells, a separate passage area is preferably provided for each battery cell. This is then located directly opposite to the relevant releasable cell vent opening of the assigned battery cell.

The specific direction is preferably a vehicle vertical direction with respect to an intended installation position in a motor vehicle. Accordingly, it is preferred that the protective plate is an underrun protection for the motor vehicle.

The sealing layer can, for example, be designed as a thin, flat structure, wherein the sealing layer can also be shaped three-dimensionally, i.e. it does not have to be completely flat. In addition, the sealing layer can also comprise a multi-layer structure.

According to a further advantageous embodiment of the invention, the sealing layer is designed as shell-shaped, so that an intermediate space is formed between the sealing layer and the degassing area, which represents the second degassing chamber. The second degassing chamber is therefore not only formed in case of degassing, but is permanently present in this example. The first and the second degassing chamber are thus arranged one above the other with respect to the specific direction and, at least in the normal case, i.e. as long as no degassing takes place, are spatially and fluidically separated from one another by the sealing layer. Due to the shell-shaped design of the sealing layer, there is very little resistance to the gas passing through the passage area in case of degassing. This enables particularly simple and reliable outgassing in case of thermal runaway of a battery cell. The sealing layer can therefore, for example, be embodied as a kind of cup that is arranged on the carrier plate below the passage area.

According to a further very advantageous embodiment of the invention, the sealing layer is arranged on the carrier plate in such a way that, in case of degassing, it detaches at least partially from the carrier plate due to temperature and/or pressure, thereby establishing the fluidic connection between the second and first degassing chamber. Thus, the gas pressure and/or the gas temperature caused by the gas emerging from the releasable cell degassing opening can advantageously be used to at least partially or completely detach the sealing layer from the carrier plate and thereby establish the fluidic connection between the second and first degassing chamber. For example, the sealing layer can be arranged on the carrier plate via a joining connection that is easy to release due to pressure and/or temperature, for example an adhesive bond. The outgassing of a battery cell then automatically causes the fluidic connection to be established between the second and the first degassing chamber.

According to a further advantageous embodiment of the invention, the sealing layer is designed such that, in case of degassing, it is at least partially destroyed due to temperature and/or pressure, thereby establishing the fluidic connection between the second and first degassing chamber. Thus, the gas pressure and/or the gas temperature caused by the gas emerging from battery cell can also advantageously be used to establish the fluidic connection between the second and first degassing chamber. For this purpose, the sealing layer according to the present example is designed such that it is at least partially destroyed, for example, ruptured and/or melted, by the gas pressure and/or the heat effect caused by the gas, by which the fluidic connection is established.

The above-mentioned examples for establishing the fluidic connection by at least partially detaching the sealing layer from the carrier plate and/or by at least partially destroying the sealing layer can also be combined with one another. In other words, the sealing layer can be arranged on the carrier plate in such a way that it is at least partially detached in case of degassing and, at the same time, can be designed in such a way that it is at least partially destroyed due to temperature and/or pressure when a battery cell outgasses. It can thus be ensured in a particularly reliable manner that the fluidic connection is established between the second and first degassing chamber in case of degassing.

According to a further advantageous embodiment of the invention, the sealing layer is designed to be dimensionally stable. It does not necessarily have to be rigid or stiff, but can also be somewhat flexible at the same time. For example, the sealing layer can be designed similarly to a yogurt cup. The sealing layer can, for example, be designed having a three-dimensional shape, as described above, and can be thin-walled. The sealing layer does not have to directly abut the degassing area in this way, which simplifies the outgassing of the cell.

According to a further advantageous embodiment of the invention, the sealing layer is designed to be flexible and/or elastic. In particular, the sealing layer can also be designed in such a way that it is flat under normal circumstances, i.e. as long as no degassing of the at least one battery cell takes place, for example, in the form of a thin film or an elastic membrane. The flexibility and/or elasticity of the sealing layer provides the possibility of designing the sealing layer in such a way that it takes on a convex shape in case of degassing and thus temporarily forms the second degassing chamber. Due to the flexibility and/or elasticity of the sealing layer, in case of degassing it can be pushed away locally particularly easily from the degassing area or passage area of the carrier plate due to the gas pressure of the emerging gas.

According to a further advantageous embodiment of the invention, the sealing layer is located in the degassing area and is designed to form the second degassing chamber in case of degassing due to the gas emerging from the cell degassing opening. This represents a particularly space-saving variant.

According to a further advantageous embodiment of the invention, the sealing layer comprises or is formed from a plastic. Especially if the sealing layer is made of a plastic or comprises a plastic, it can be designed in a particularly simple manner so that it is at least partially destroyed in case of degassing, for example, melts and/or tears, in order to establish the fluidic connection between the second and first degassing chamber. For example, such a plastic can comprise or represent polypropylene and/or polyamide. Other plastics are also conceivable.

According to a further advantageous embodiment of the invention, the cell group comprises multiple battery cells, each of which has a releasable cell degassing opening which is opposite to a respective passage area of the carrier plate, wherein the passage areas are arranged in the same degassing area, in particular wherein the battery assembly comprises multiple cell groups, wherein each cell group is assigned to a degassing area of the carrier plate, and each cell group is assigned a sealing layer which is arranged on the carrier plate so as to cover the degassing area of the carrier plate assigned to the cell group.

On the one hand, it is advantageous if a common sealing layer is provided for a cell group. This means that a separate such sealing layer does not have to be provided for each individual battery cell. If the battery assembly also comprises multiple cell groups, in particular each having multiple battery cells, an associated sealing layer can be provided for each cell group. This in turn makes it easier to seal the respective sealing layers to the carrier plate, since such a sealing layer can then be designed to be correspondingly smaller and, for example, does not have to cover the entire high-voltage battery.

A cell group can, for example, be provided in the form of a cell stack having multiple battery cells arranged adjacent to one another in a stacking direction. In particular, the battery assembly can comprise a battery, for example, a high-voltage battery, which in turn comprises the multiple cell groups. The battery can comprise a battery housing in which the multiple cell groups are arranged, wherein the housing base of the battery housing can represent the carrier plate.

Furthermore, the invention also relates to a motor vehicle having a battery assembly according to the invention or one of its designs. The motor vehicle can be designed as an electric vehicle, for example.

The motor vehicle according to the invention is preferably designed as an automobile, in particular as a passenger car or truck, or as a passenger bus or motorcycle.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In the FIGURE:

FIG. 1 shows a schematic cross-sectional illustration through a battery assembly according to an exemplary embodiment of the invention;

### DETAILED DESCRIPTION

The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also predetermined to comprise combinations of the features of the embodiments other than those represented. Furthermore, the described embodiments can also be supplemented by further ones of the above-described features of the invention.

In the FIGURES, identical reference signs each designate functionally-identical elements.

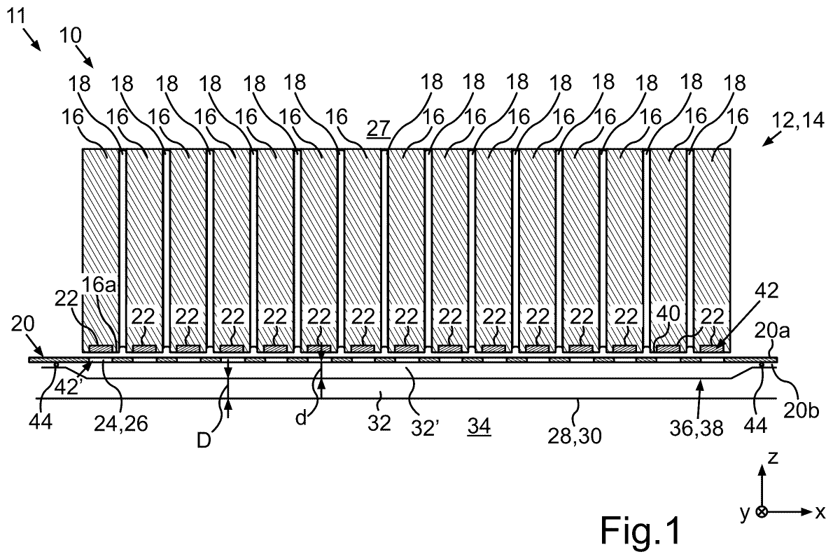

FIG. 1 shows a schematic cross-sectional illustration of a battery assembly 11 having a battery 10 according to an exemplary embodiment of the invention. The battery 10 can be designed, for example, as a high-voltage battery 10. The battery 10 comprises at least one cell group 12. In this example, the cell group 12 is provided in the form of a cell stack 14 comprising multiple battery cells 16 arranged adjacent to one another in a stacking direction x. An intercell material 18 or cell separating element 18 or the like can be arranged between the two battery cells 16 arranged adjacent to one another in the stacking direction x.

Furthermore, the battery assembly 11 comprises a carrier plate 20. The carrier plate 20 can, for example, simultaneously be designed as a cooling plate. The carrier plate 20 has a first plate side 20a and an opposite plate side 20b, which can also be called first carrier side 20a and second carrier side 20b. The first plate side 20a faces toward the cell group 12. The battery cells 16 also each have a releasable cell degassing opening 22, for example a bursting membrane or the like. This can also be called a cell vent 22. These cell vents 22 are arranged in the present case on the respective lower side 16a of a respective battery cell 16 and thus face toward the first carrier side 20a. The carrier plate 20 has an assigned passage area 24 for each battery cell 16. In the simplest case, the passage areas 24 can be designed as holes 26 in the carrier plate 20. These holes 26, which thus represent through openings, can optionally also be covered by a protective film or protective cover or a protective mat or the like. The carrier plate 20 can therefore be designed as a perforated plate. Each passage area 24 is located directly opposite to a respective releasable cell degassing opening 16a with respect to the z direction. In case of degassing of a battery cell 16, the gas emerging from the battery cell, more precisely the gas emerging from its releasable cell degassing opening 16a, can thus penetrate the carrier plate 20 through this passage area 24. This allows the gas to be safely discharged from an interior 27 of the battery 10.

With respect to the z direction, a protective plate 28 is also arranged below the carrier plate 20, which in particular represents an underrun protection 30 of a motor vehicle in which the battery 10 or the battery assembly 11 is used. This protective plate 28 can cover the entire battery 10 in the x-y plane. As a result, a degassing chamber 32 is advantageously provided between the carrier plate 20 and the protective plate 28, which is also referred to here as the first degassing chamber 32.

If, in case of degassing, degassing takes place into such a degassing chamber 32 between the carrier plate 20 and the underrun protection 30, above all the water sealing of the battery 10 is more challenging, since such an underrun protection 30 is directly adjacent to the surroundings 34, in particular of the motor vehicle in which the battery assembly 11 is used. In order to enable such sealing, for example, the underrun protection 30 itself can be designed to be fluid-tight and/or connected in a fluid-tight manner to the carrier plate 20 or to another housing component of a battery housing of the battery 10.

However, due to the size of typical high-voltage batteries, the sealing concept for conventional batteries is very complex in this case.

The invention or its embodiments now advantageously make it possible to introduce, in particular, additional water sealing. This is provided in particular by a sealing layer 36 which is arranged on the carrier plate 20. The sealing layer 36 is provided in the form of a cup 38 in a long tub design in the present case. In other words, this cup 38 extends in the x direction over the entire cell stack 14.

For the cell group 12, a degassing area 42 can be defined, which represents the region, in particular the module lower side 40, in which all cell degassing openings 22 of the battery cells 16 comprised by the cell stack 14 are arranged. The area of the carrier plate 20 which is directly opposite to this degassing area 42 with respect to the z-direction can represent a corresponding degassing area 42′ of the carrier plate, which correspondingly comprises all passage areas 24 of the same cell stack 14. The sealing layer 36, in particular the cup 38, is now joined to the second carrier side 20b in a sealing manner along a closed sealing contour 44, which extends closed around the degassing area 42′ of the carrier plate 20. Accordingly, the sealing layer 36 completely covers the degassing area 42′ of the carrier plate 20 and also the degassing area 42 of the cell group 12. The sealing layer 36 can, for example, be adhesively bonded or fastened in some other way to the carrier plate 20 via such a sealing contour 44. Within this sealing contour 44, the cup 38 has a distance d from the carrier plate 20 in the present case and correspondingly from the releasable cell degassing openings 22 located above it. As a result, a second degassing chamber 32′ is provided between the carrier plate 20 and the cup 38. Normally, as long as no degassing of a battery cell 16 takes place, the first and second degassing chambers 32, 32′ are spatially and fluidically separated from each other. The distance to the cells 16 enables particularly simple and unobstructed outgassing of the affected cell in case of degassing. This can prevent the cup 38 from blocking the degassing when a cell 16 is outgassing. Furthermore, the cup 38 is preferably designed such that in case of outgassing of a battery cell 16, a fluidic connection is established between the first and second degassing chambers 32, 32′. For example, the cup 38 can open with the opening pressure of the cell 16, which is usually approximately 6 bar to 9 bar, and in particular also without additional temperature input, thereby establishing the fluidic connection between the first and second degassing chambers 32, 32′. For this purpose, the cup 38 can be at least partially detached from the carrier plate 20 and/or at least partially destroyed, for example, by melting or tearing or the like. The cup 38 can therefore, for example, detach or open with the first pressure wave in case of degassing. The cup 38 can be designed such that it tears and/or dissolves and/or detaches as directly as possible after the thermal runaway of a battery cell 16, because this can particularly efficiently prevent a temperature increase in the neighboring cells of the cell 16 experiencing thermal runaway. In addition, further protective measures can be provided to protect the neighboring cells 16, for example a potting material between the cell vent 22 and the carrier plate 20.

Furthermore, it is advantageous if the cup 38 also has a distance D from the protective plate 28, although this does not necessarily have to be the case. As a result, the entire assembly is better protected against external applications of force, particularly from below on the protective plate 28. This also makes it possible to provide a smaller volume of the second degassing chamber 32′, which simplifies the pressure-related establishment of the fluidic connection in the case of degassing due to the resulting faster pressure build-up.

The battery 10 can, for example, comprise multiple such cell groups 12. These can, for example, be arranged adjacent to one another in the y direction and/or x direction. For each such cell group 12, for example, a separate sealing layer 36 can be provided.

Overall, the examples show how the invention can provide a cup for water sealing between the underbody and the high-voltage compartment of the high-voltage battery. In particular, this enables sealing of the high-voltage battery cooling plate at the degassing interfaces. This sealing measure can in particular be combined in any way with optional additional sealing measures. The invention enables the introduction of “yogurt cups” in a long tub design, which are attached, adhesively bonded, or fastened between the cell vents of multiple cells and the underrun protection and fulfill the sealing function with respect to the outside of the high-voltage area or cell area or contact area. The cups are preferably spaced apart from the cell vent so as not to block it from degassing. The cups enable outgassing via the degassing volume, preferably at the opening pressure of the cell, even without temperature input. The cup can therefore detach or open with the first pressure wave. The cups can also dissolve as soon as possible after thermal runaway to avoid causing a temperature increase in the neighboring cells of the cell experiencing thermal runaway. By providing such a cup below the cell vents or the carrier plate, a significantly more robust water seal can be provided. In addition, this does not restrict the degassing behavior and also allows for easy installation of the water seal. Such a cup can also be implemented independently of the protection concept of the cell vent. The cup can represent the only water seal between the surroundings and the battery compartment, or can be a supplementary water seal to other protection concepts, for example an additional seal of the underrun protection against the carrier plate or the like.

1. A battery assembly for a motor vehicle, comprising:
a cell group having at least one battery cell, which has a releasable cell degassing opening,
a carrier plate having a first carrier side, having a second carrier side opposite to the first carrier side, and having at least one passage area assigned to the at least one battery cell, wherein the at least one battery cell is arranged on the first carrier side in such a way that the releasable cell degassing opening faces toward the first carrier side and is opposite to the passage area, wherein the carrier plate has a degassing area, in which the passage area is arranged,
a protective plate arranged below the carrier plate with respect to a specific direction and facing toward the second carrier side of the protective plate, and
a first degassing chamber between the protective plate and the carrier plate, into which, in case of degassing, a gas emerging from the releasable cell degassing opening is introducible through the passage area,
wherein the battery assembly comprises a sealing layer which is arranged on the second carrier side and which is joined to the second carrier side to form a seal along at least one closed sealing contour, which extends closed around the degassing area of the carrier plate, and which sealing layer covers the degassing area and separates it from the first degassing chamber,
wherein a second degassing chamber is formed between the degassing area and the sealing layer or can be formed in the case of degassing,
wherein the battery assembly is designed such that the second degassing chamber is only temporarily fluidically separated from the first degassing chamber in case of degassing, and a fluidic connection is established between the first and second degassing chambers in case of degassing.

2. The battery assembly according to claim 1, wherein the sealing layer is designed as shell-shaped, so that an intermediate space is formed between the sealing layer and the degassing area, which represents the second degassing chamber.

3. The battery assembly according to claim 1, wherein the sealing layer is arranged on the carrier plate in such a way that, in case of degassing, it detaches at least partially from the carrier plate due to temperature and/or pressure, thereby establishing the fluidic connection between the second and first degassing chamber.

4. The battery assembly according to claim 1, wherein the sealing layer is designed such that, in case of degassing, it is at least partially destroyed due to temperature and/or pressure, thereby establishing the fluidic connection between the second and first degassing chamber.

5. The battery assembly according to claim 1, wherein the sealing layer is designed to be dimensionally stable.

6. The battery assembly according to claim 1, wherein the sealing layer is designed to be flexible and/or elastic.

7. The battery assembly according to claim 1, wherein the sealing layer abuts the degassing area and is designed to form the second degassing chamber in case of degassing due to the gas emerging from the cell degassing opening.

8. The battery assembly according to claim 1, wherein the sealing layer is made of a plastic or comprises a plastic.

9. The battery assembly according to claim 1, wherein the cell group comprises multiple battery cells, each of which has a releasable cell degassing opening which is opposite to a respective passage area of the carrier plate, wherein the passage areas are arranged in the degassing area, in particular wherein the battery assembly comprises multiple cell groups, wherein each cell group is assigned to a degassing area of the carrier plate, and each cell group is assigned a sealing layer which is arranged on the carrier plate so as to cover the degassing area of the carrier plate assigned to the cell group.

10. A motor vehicle having a battery assembly according to claim 1.

11. The battery assembly according to claim 2, wherein the sealing layer is arranged on the carrier plate in such a way that, in case of degassing, it detaches at least partially from the carrier plate due to temperature and/or pressure, thereby establishing the fluidic connection between the second and first degassing chamber.

12. The battery assembly according to claim 2, wherein the sealing layer is designed such that, in case of degassing, it is at least partially destroyed due to temperature and/or pressure, thereby establishing the fluidic connection between the second and first degassing chamber.

13. The battery assembly according to claim 3, wherein the sealing layer is designed such that, in case of degassing, it is at least partially destroyed due to temperature and/or pressure, thereby establishing the fluidic connection between the second and first degassing chamber.

14. The battery assembly according to claim 2, wherein the sealing layer is designed to be dimensionally stable.

15. The battery assembly according to claim 3, wherein the sealing layer is designed to be dimensionally stable.

16. The battery assembly according to claim 4, wherein the sealing layer is designed to be dimensionally stable.

17. The battery assembly according to claim 2, wherein the sealing layer is designed to be flexible and/or elastic.

18. The battery assembly according to claim 3, wherein the sealing layer is designed to be flexible and/or elastic.

19. The battery assembly according to claim 4, wherein the sealing layer is designed to be flexible and/or elastic.

20. The battery assembly according to claim 5, wherein the sealing layer is designed to be flexible and/or elastic.
